(19) United States
(12) Patent Application Publication
(10) Pub. No.: US 2005/0220046 A1
(43) Pub. Date: Oct. 6, 2005

(54) Token-controlled formation of wireless work groups

(76) Inventors: Thomas Falck, Aachen (DE); Henning Maab, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/517,456

(22) PCT Filed: Jun. 10, 2003
(86) PCT No.: PCT/IB03/02206

§ 371 Date: Dec. 8, 2004

(30) Foreign Application Priority Data
Jun. 13, 2002 (DE) 102 26 304.3

(51) Int. Cl. G06F 15/16; H04J 1/10; H04J 3/08; H04B 7/14

(52) U.S. Cl. 370/315; 709/208

(57) ABSTRACT

The invention relates to a method of operating a network of a plurality of communication apparatuses (1, 2, 5 to 8) and particularly to a method of operating an ad hoc network between Bluetooth apparatuses. A token (3, 9 to 12, 15), in which the apparatus address of the associated apparatus is stored, is assigned to a plurality of communication apparatuses (1, 2, 5 to 8). At least one communication apparatus is used as a token read apparatus (4, 13 and 14) so as to read the apparatus address of a first communication apparatus (1), stored in the token (3, 9 to 12, 15). The token read apparatus (4, 13 and 14) builds up a connection with the first communication apparatus (1) by means of the apparatus address, and/or the apparatus address is transmitted by the token read apparatus (4, 13 and 14) to at least a second communication apparatus (2). The second communication apparatus (2) can then build up a connection with the first communication apparatus (1).

The invention relates to a method of operating a network between a plurality of communication apparatuses, and particularly a method of operating an ad hoc network between Bluetooth apparatuses.

Wireless transmission technologies such as, for example, Bluetooth enable mobile apparatuses to spontaneously form a network without any previous configuration. Such networks are referred to as ad hoc networks. The apparatuses of a Bluetooth ad hoc network optionally operate as masters or slaves in a network. An apparatus operating as a master co-ordinates the overall communication in the network and manages a plurality of slaves. It can maintain a connection with a plurality of slaves simultaneously so that a star-shaped net topology of the network is obtained.

A wireless connection between the master and the slave is realized by a Bluetooth specification in which various electronic apparatuses can build up point-to-point or point-to-multiple point connections so as to be able to transmit and receive data. The Bluetooth specification is characterized by a large bandwidth in the radio frequency range. A connection build-up between a plurality of Bluetooth apparatuses is obtained with the aid of inquiry and page operations which cannot be properly performed without the co-ordination and management functions of the master. An inquiry operation is performed to determine the apparatus address of a remote apparatus. If the apparatus address of a remote apparatus is known, a communication connection with the remote apparatus can be built up by means of a page operation.

The publication “Bluetooth aktuell—Technik und Anwendungen” by Prof. Dr. Jörg Wollert, Elektronik 20/2001, pages 76 to 81, describes the formation of piconetworks and particularly the connection build-up. In each piconetwork there is one master so that all other apparatuses of the piconetwork are slaves. All apparatuses of a piconetwork can communicate with each other via the master, while an apparatus may be simultaneously present in a plurality of piconetworks and takes over the function of master in at most one piconetwork. Furthermore, an essential problem in using the Bluetooth standard is evident from this publication. When an apparatus is not connected to a piconetwork, the apparatus itself or a master must start inquiry and page operations so as to establish a connection with the master.

The formation of a piconetwork is elucidated with reference to an example. A Bluetooth apparatus (BG₁) initially performs a so-called device discovery which consists of an inquiry operation. The result of the device discovery is a list with the apparatus addresses (GA₂, . . . , GAₙ) of all Bluetooth apparatuses (BG₂, . . . , BGₙ) that can be reached in the vicinity of BG₁. The piconetwork is built up successively, i.e. BG₁ is the first apparatus to build up a connection by means of a page operation with the BG₂ which is unambiguously identified by its apparatus address GA₂. The result is a piconetwork consisting of BG₁ and BG₂. The apparatus initiating the connection becomes the master of the new piconetwork. Thus, in the example, BG₁ is the master of the piconetwork and BG₂ is a slave. Subsequently, BG₁ builds up consecutive connections with the other apparatuses BG₃ . . . , BGₙ so that the piconetwork is gradually enlarged.

The Bluetooth standard defines how an apparatus can build up a connection with another apparatus. However, it does not determine who should try to build up a connection with whom and when. A connection build-up is therefore either initiated by a user or by means of an application program.

Consequently, situations may easily occur in which a plurality of users simultaneously attempts to discover other apparatuses and build up piconetworks. This is a problem for a number of reasons. For example, apparatuses simultaneously performing a device discovery (apparatus inquiry) cannot discover one another. Under circumstances, the device discovery thus yields only an incomplete result, as a device discovery typically takes 30 to 60 seconds.

Instead of a large piconetwork, many small piconetworks may be created. These networks must then be elaborately converted by a plurality of master/slave exchange operations into one common piconetwork.

While users of wired networks can easily recognize by tracking the cable which apparatuses are connected together, this is only possible in wireless networks by means of programs visualizing the network topology. Since radio waves go through walls, it can easily happen that apparatuses from neighboring rooms are taken up in the piconetwork inadvertently and unnoticed, so that this creates a security risk.

The build-up of a piconetwork is therefore a complicated process for inexperienced users and requires a matched procedure by all users. Moreover, in present-day Bluetooth apparatuses, a user cannot limit the release of data stored in the apparatus to a special piconetwork.

It is an object of the invention to provide a method of operating an ad hoc network between Bluetooth apparatuses in which an uncomplicated connection build-up takes place.

This object is solved by a method of the type described in the opening paragraph in that a token identifying a communication apparatus via an apparatus address is assigned to a plurality of communication apparatuses and at least one communication apparatus serves as a token read apparatus in which the apparatus address of a first communication apparatus stored in the token is read by the token read apparatus, and the token read apparatus builds up a connection with the first communication apparatus by means of the apparatus address, and/or the apparatus address is transmitted by the token read apparatus to at least a second communication apparatus, and the second communication apparatus builds up a connection with the first communication apparatus.

A token which has stored the apparatus address of the communication apparatus in a read-only memory is assigned to each communication apparatus. Each token can be read by a token read apparatus and the apparatus address which has been read is passed on to the second communication apparatus and/or the token read apparatus itself establishes a connection with the communication apparatus by means of the apparatus address. To read the token, the token is brought into the vicinity of or inserted into the token read apparatus itself in which it stays until the connection is terminated. To terminate the connection, a user removes the token from the token read apparatus.

This solution is very advantageous because the connection build-up and disconnection can easily be initiated by the user by inserting or removing the token into or from the token read apparatus so that it is very rapid and user-friendly.

The token read apparatus may have, for example, the shape of a holder for accommodating tokens which have the shape of, for example, a coin or a pen.

The holder may be formed in such a way that it can accommodate only a given number of tokens. The maximum number of simultaneous connections can thereby be controlled. For example, a projector which can be used any time by one user only may have a token holder which can accommodate exactly one token. Storage and reading of the apparatus addresses can be realized, for example, by means of a RFID technology.

The dependent claims define advantageous improvements of the invention.

The embodiment as defined in claim 2 particularly relates to communication apparatuses operating in accordance with the Bluetooth standard, which apparatuses are referred to as Bluetooth apparatuses. By using tokens and suitable token read apparatuses, an otherwise conventional device discovery of the Bluetooth apparatuses is no longer necessary because the apparatus address can be read directly from the token.

After the token read apparatus has established a connection with a first Bluetooth apparatus, both Bluetooth apparatuses constitute a piconetwork in which the token read apparatus fulfills the function of a master and the first Bluetooth apparatus fulfills the function of a slave. As slaves, further Bluetooth apparatuses can become members of the piconetwork in that their tokens are inserted into the token read apparatus and the token read apparatus has established a connection with them.

The contents of the token read apparatus thus always reflect the composition of the piconetwork and visualize the actual network topology of the network in this way.

For reasons of security, a password stored in the token may be requested for the connection build-up. Additionally, information about resources to be used may be stored in the token. Such information may be electronic paths to documents such as, for example, documents to be printed which are to be published by a given printer, or stored presentations which are to be displayed by a projector.

A plurality of tokens may be assigned to a Bluetooth apparatus in that a plurality of tokens store the same apparatus address. The tokens are then distributed on a plurality of token read apparatuses. Consequently, a Bluetooth apparatus operating as a slave may be represented simultaneously in a plurality of piconetworks.

In order to make it possible to additionally assign a given quantity of documents to each token, which documents are released for reading by the members of the piconetwork, each token comprises a token identification number (token-ID). In addition to the apparatus addresses, each token also stores its unambiguous token-ID for all apparatuses. A Bluetooth apparatus with a plurality of tokens can assign different documents to each token with reference to the token-ID.

Each Bluetooth apparatus stores an assignment between token-IDs and a name on a list with these documents released for reading and assigned to this token.

The list of released documents consists of filed document names (file-ID) and a physical path associated with each file-ID. When inserting a token into a token read apparatus, not only the apparatus address but also the token-ID is read.

The Bluetooth apparatus operating as a maser in the piconetwork stores a table with the assignment of the apparatus address and token-IDs. By means of the apparatus address, the Bluetooth apparatus operating as a maser can connect with a Bluetooth apparatus operating as a slave and inform this apparatus of the corresponding token-ID.

The Bluetooth apparatus operating as a slave stores a table with the associated token-IDs and the apparatus addresses of the Bluetooth apparatus operating as a master, in which the corresponding tokens are present.

These and other aspects of the invention are apparent from and will be elucidated with reference to the embodiments described hereinafter.

In the drawings:

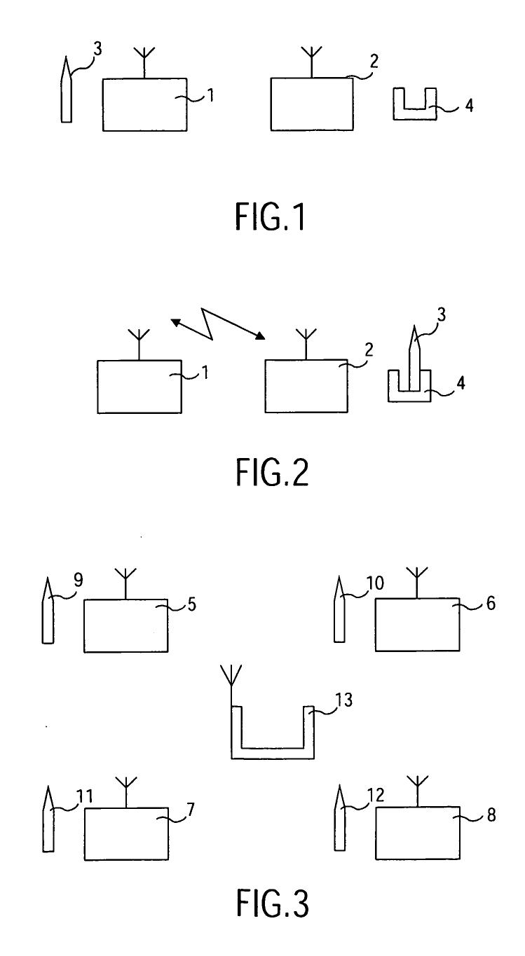

FIG. 1 shows a first Bluetooth apparatus with a token and a second Bluetooth apparatus with a token read apparatus;

FIG. 2 shows a Bluetooth piconetwork as an example of a network with a wireless transmission between two Bluetooth apparatuses;

FIGS. 3 to 5 show the build-up of a piconetwork with a master; and

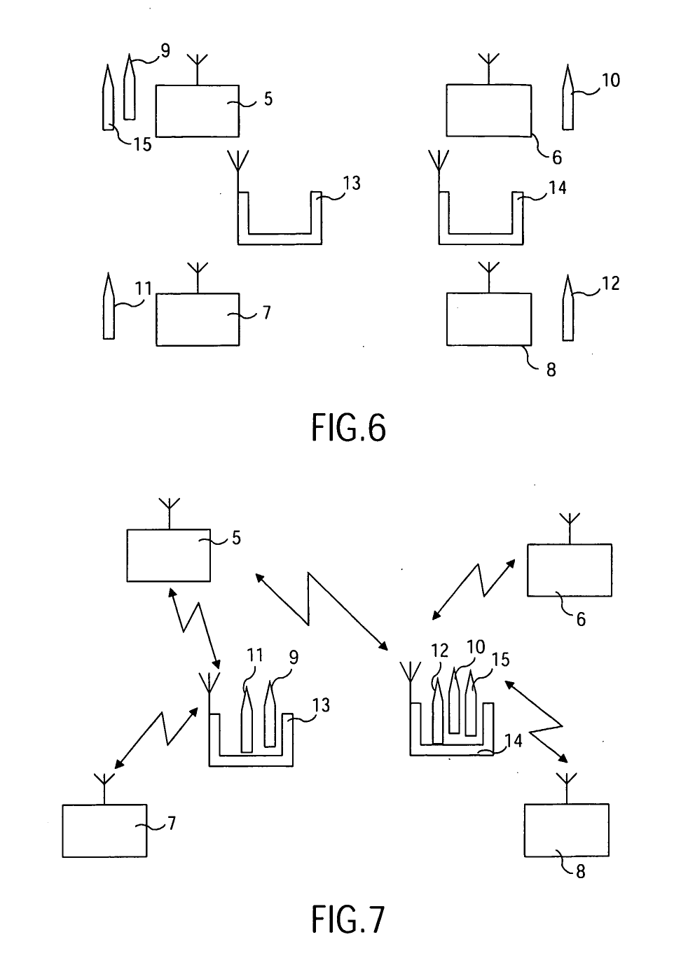

FIGS. 6 and 7 show the build-up of two piconetworks, each with a master.

FIG. 1 shows two Bluetooth apparatuses 1 and 2. Bluetooth apparatuses are mobile or stationary communication apparatuses such as, for example, mobile phones, notebooks, PDAs, cash registers, access control devices or multimedia kiosks. A token 3 having the shape of, for example, a pen is assigned to the first Bluetooth apparatus 1. A token is always assigned to only one mobile Bluetooth apparatus. The token 3 has a read-only memory in which the apparatus address of the Bluetooth apparatus 1 is stored.

The second Bluetooth apparatus 2 communicates with a token read apparatus 4. The token read apparatus 4 has the shape of a holder and is capable of accommodating the token as well as read the stored apparatus address so as to pass it on to the Bluetooth apparatus 2.

A user of the Bluetooth apparatus 1, which is a mobile phone, would like to connect the Bluetooth apparatus 1 to the Bluetooth apparatus 2. The Bluetooth apparatus 2 is a PC whose data such as, for example, address book files should be updated by the mobile phone. To this end, the user inserts the token 3 into the token read apparatus 4. The token read apparatus 4 reads the apparatus address of the mobile phone and transmits it to the PC. The PC can establish a connection with the mobile phone by means of the apparatus address.

FIG. 2 shows two Bluetooth apparatuses 1 and 2 which communicate with each other. The token 3 of the Bluetooth apparatus 1 is present in the token read apparatus 4. The Bluetooth apparatuses 1 and 2 exchange data via the wireless connection (shown as a double arrow in FIG. 2 and subsequent Figures).

FIGS. 3 to 5 demonstrate the build-up of a piconetwork with a master. Identical or corresponding elements and components in the following Figures are denoted by the same reference numerals.

FIG. 3 shows four Bluetooth apparatuses which have the role of slaves in a piconetwork after a connection build-up and are therefore denoted as slaves 5 to 8. A token 9 to 12 is assigned to each slave 5 to 8. Each token 9 to 12 has a read-only memory which stores the apparatus address of the slaves 5 to 8 assigned to it, as well as additional information. Additional information may be a token-ID or electronic paths referring to electronic documents. A slave 5 to 8 can identify its token 9 to 12 by means of the token-ID.

Furthermore, a Bluetooth apparatus operating as a token read apparatus is shown. The token read apparatus has the form of a holder and fulfills the role of a master in the piconetwork after a connection build-up and is therefore denoted as master 13.

The slaves 5 to 8 and the master 13 do not have a mutual connection. The tokens 9 to 12 are in the vicinity of the respective slaves 5 to 8.

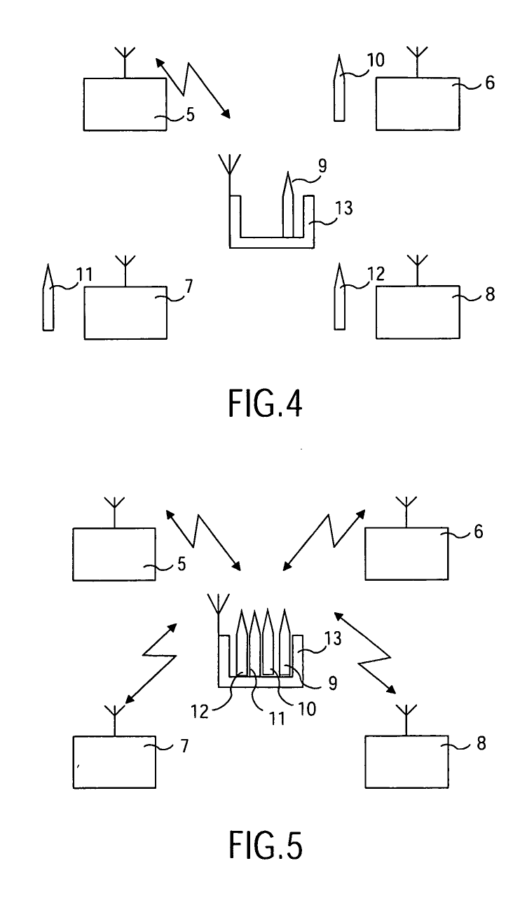

FIG. 4 shows the slaves 5 to 8 and their tokens, as well as the master 13. The token 9 of the slave 5 is present in the holder of the master 13.

A user of the slave 5 would like to establish a connection with master 13. To this end, he inserts the token 9 assigned to the slave 5 into the holder of the master 13. When the token 9 is inserted, a reader built in the holder of the master 13 reads a data file, stored in the token 9, with the apparatus address of the slave 5. The master 13 uses this apparatus address to build up a connection with the slave 5. As a result, a piconetwork is obtained which consists of the master 13 and the slave 5.

FIG. 5 again shows the slaves 5 to 8 and their tokens 9 to 12, as well as the master 13. All tokens 9 to 12 are present in the holder of the master 13.

The user of the slaves 6 to 8 would like to establish a connection with the master 13 so as to take part in the communication, as nodes in the piconetwork. To this end, each user inserts the relevant tokens 10 to 11 in the holder of the master 13. When the tokens 10 to 12 are inserted in the master 13, the reader reads the data file, stored in the tokens 10 to 12, with the corresponding apparatus address and can establish a connection with the slaves 6 to 8 corresponding to the apparatus address.

After the master 13 has read all apparatus addresses and has built up a connection with each slave 5 to 8, a piconetwork with the slaves 5 to 8 and a master 13 is created in a star topology. A composition of the piconetwork is again reflected in the contents of the holder.

FIGS. 6 and 7 show the build-up of two piconetworks, each with a master and a plurality of slaves. The description with reference to FIGS. 3 to 5 is taken as a reference and only the differences will be elucidated hereinafter.

In this embodiment, a token 15 is assigned in addition to the token 9 to the slave 5. A further token read apparatus takes over the role of a master and is therefore denoted as master 14.

The masters 13 and 14 shown in FIG. 6 do not comprise any one of the tokens and, consequently, the slaves 5 to 8 do not have a connection with any one of the masters 13 and 14.

To build up a connection with the master 13 and the master 14, the user of the slave 5 inserts the token 9 into the master 13 and the token 15 into the master 14. Both masters read the apparatus address of the slave 5, stored in the respective tokens 13 and 15, and then each establish a connection with the slave 5.

Analogously, the users of the slaves 6 and 8 insert the tokens 10 and 12 into the holder of the master 14, which establishes a connection with slaves 6 and 8. The token 11 of the slave 7 is placed in the holder of the master 13. Master 13 reads the apparatus address of the slave 7 and builds up a connection with slave 7.

FIG. 7 shows a first piconetwork which consists of the slaves 5 and 6 and the master 13. The tokens 11 and 9 are present in the master 13. A second piconetwork consists of the slaves 5, 6 and 8 with the associated master 14. The tokens 10, 12 and 15 are present in the master 14.

The master 13 communicates with slaves 5 and 7. The master 14 has built up a connection with slaves 5, 6 and 8. Slave 5 can communicate both with master 13 and with master 14.

The user of the slave 5 has two tokens 9 and 15 in order that he can release different documents for reading by different users. A given quantity of documents is to be accurately assigned to each token. The user may, for example, assign two documents D1 and D2 to token 9 and a document D3 to token 15. When he inserts token 9 into the holder of master 13 and token 15 into the holder of master 14, slave 7 of the first piconetwork and master 13 can read the documents D1 and D2. The slaves 6 and 8 of the second piconetwork and master 14 can read document D3 of slave 5.

The release of documents and a data structure of the piconetwork based thereon will be elucidated with reference to the first piconetwork.

The slave 5 has the apparatus address 01 02 03 04 05 06, slave 7 is unambiguously identified by the apparatus address 0A 0B 0C 0D 0E 0F, master 13 has 12 13 14 15 16 17 as apparatus address and master 14 has the apparatus address 21 23 43 21 12 45. The tokens 15 and 9 of the slave 5 and token 11 of the slave 7 have unambiguous token-IDs for all apparatuses. Each token 15 and 9 not only stores the apparatus address but also its token-ID. The token 9 has the token-ID 01 02 06, token 15 has the token-ID 03 05 07 and token 11 has 21 22 16 as a token-ID. The following Table shows an unambiguous assignment of the token 9 to the slave 5. The Table is stored in token 9.

| Apparatus address | Token-ID |
|---|---|
| 01 02 03 04 05 06 | 01 02 06 |

Each slave 5 and 7 has an assignment between token-ID and a list identification number characterizing a list with the documents assigned to this token and released for reading. For the tokens 9 and 15 of the slave 5, the assignment is shown in the following Table. The Table is stored in slave 5.

| Token-ID | List-ID |
|---|---|
| 01 02 06 | 1 |
| 03 05 07 | 2 |

A plurality of list-IDs may also be assigned to a token-ID. A list of the released documents consists, per entry, of a document identification unit (file-ID) and a physical path. The following Table shows the list with list-ID=1.

List for document-List-ID = 1

| File-ID | Path |
|---|---|
| 1 | C:\abc\test.doc |
| 2 | C:\temp\brief.doc |

When inserting the token 9 into the holder of the master 13, not only the apparatus address but also the token-ID is read.

The master 13 sets up a Table with an assignment of apparatus addresses and token-IDs for the slaves 5 and 7. The following Table shows such an assignment. The table is stored in master 13.

| Apparatus address of the slaves | Token-ID |
|---|---|
| 01 02 03 04 05 06 | 01 02 06 |
| 0A 0B 0C 0D 0E 0F | 21 22 16 |

Then the master 13 establishes a connection with the corresponding slaves 5 and 7 with reference to the apparatus address, as described hereinbefore. The master 13 informs the slave 5 of the token-ID of the token 9. Analogously, the master 13 informs the slave 7 of the token-ID of the token 11.

The slave 5 thereupon sets up a Table with the token-ID and the apparatus address of the master 13. The Table is stored in slave 5.

| | Apparatus address of the |
|---|---|
| Token-ID | master |
| 01 02 06 | 12 13 14 15 16 17 |
| 03 05 07 | 21 23 43 21 12 45 |

The Table also comprises the token-ID of the token 15, analogously transmitted from the master 14 to the slave 5, as well as the apparatus address of the master 14.

A communication between the master 13 and slaves 5 and 7 is initiated by the software program parts implemented in the slaves 5 and 7, such as the methods GetFileList(token-ID) and GetFile(token-ID, file-ID). Inquiries are only accepted for security reasons by the master 13 associated with the token-ID. To this end, the slave 5 uses the Table which comprises the assignment of the token-ID to the apparatus address of the master 13. The method GetFileList(token-ID) yields the list of released documents, assigned to the token-ID. The method GetFile(token-ID, file-ID) supplies back the document specified by the file-ID.

When a slave is new in the piconetwork, the master 13 calls the method GetFileList for the new slave and distributes the result of the method GetFileList as well as the apparatus address and the token-ID among all slaves of the piconetwork. The new slave directs the method GetFileList and GetFile as inquiries to the master 13 which passes on the inquiries to the slaves 5 and 7.

When the new slave leaves the piconetwork, the master 13 informs all remaining slaves 5 and 7 that the new slave with the previously released documents is no longer available.

1. A method of operating a network between a plurality of communication apparatuses (1, 2, 5 to 8) each having a token (3, 9 to 12, 15) identifying a communication apparatus (1, 2, 5 to 8) via an apparatus address, and at least one communication apparatus used as a token read apparatus (4, 13 and 14), in which the apparatus address of a first communication apparatus (1), stored in the token (3, 9 to 12, 15) is read by the token read apparatus (4, 13 and 14), and the token read apparatus (4, 13 and 14) builds up a connection with the first communication apparatus (1) by means of the apparatus address, and/or the apparatus address is transmitted by the token read apparatus (4, 13 and 14) to at least a second communication apparatus (2), and the second communication apparatus (2) builds up a connection with the first communication apparatus (1).

2. A method as claimed in claim 1, characterized in that the network is a network operating in accordance with the Bluetooth standard.

3. A method as claimed in claim 2, characterized in that at least the token read apparatus (4, 13 and 14) and the first communication apparatus (1) are provided for forming a piconetwork.

4. A method as claimed in claim 2, characterized in that the token read apparatus (13 and 14) fulfills the function of a master and further communication apparatuses (1, 2, 5 to 8) fulfill the function of slaves in the network.

5. A method as claimed in claim 1, characterized in that a password stored in the token (3, 9 to 12, 15) is read by the token read apparatus (4, 13 and 14).

6. A method as claimed in claim 1, characterized in that the token read apparatus (4, 13 and 14) is provided for accommodating a given number of tokens (3, 9 to 12, 15).

7. A method as claimed in claim 1, characterized in that the token (3, 9 to 12, 15) comprises information about network resources.

8. A method as claimed in claim 1, characterized in that the token (3, 9 to 12, 15) comprises information about a release of documents.

9. A method as claimed in claim 1, characterized in that a plurality of tokens (9, 15) is assigned to a communication apparatus (1, 2, 5 to 8) and a token identification number (token-ID) is assigned to each token (9, 15).

10. A method as claimed in claim 9, characterized in that an assignment of the token identification number and a name (list-ID) identifying a list of documents is stored in a communication apparatus (1, 2, 5 to 8) operating as a slave.

11. A method as claimed in claim 10, characterized in that the list of documents consists of a document identification unit (file-ID) and a path assigned to the document identification unit.

12. A method as claimed in claim 9, characterized in that a communication apparatus (13 and 14) operating as a master stores an assignment consisting of apparatus addresses and token-IDs.

13. A method as claimed in claim 9, characterized in that the communication apparatus (1, 2, 5 to 8) operating as a slave stores an assignment of token identification numbers and apparatus addresses of the communication apparatuses operating as masters (13 and 14).

14. A communication system comprising a plurality of communication apparatuses (1, 2, 5 to 8) and each with a token (3, 9 to 12, 15) identifying a communication apparatus (1, 2, 5 to 8) via an apparatus address, as well as at least one communication apparatus used as a token read apparatus (4, 13 and 14), wherein:
the token read apparatus (4, 13 and 14) is provided for reading the apparatus address of a first communication apparatus (1), stored in the token (3, 9 to 12, 15); and
the token read apparatus (4, 13 and 14) is provided for building up a connection with the first communication apparatus (1) by means of the apparatus address; and/or
the token read apparatus (4, 13 and 14) is provided for transmitting the apparatus address to at least a second communication apparatus (2), and the second communication apparatus (2) is provided to build up a connection with the first communication apparatus (1).
